(19) United States
(12) Patent Application Publication
(10) Pub. No.: US 2011/0264306 A1
(43) Pub. Date: Oct. 27, 2011

(54) Lifting Vehicle

(76) Inventor: Niels Henrik Bagge, Slagelse (DK)

(21) Appl. No.: 13/124,442

(22) PCT Filed: Oct. 17, 2008
(86) PCT No.: PCT/IB2008/002755

§ 371 Date: Jul. 11, 2011

(51) Int. Cl. B66F 9/06; G06F 17/00; B66F 9/18

(52) U.S. Cl. 701/2; 414/560

(57) ABSTRACT

The invention concerns a lifting vehicle (1) comprising a chassis (2) with moving support elements (3), a tower structure (4) mounted thereon, said tower (4) being provided with a pivoting and telescopic boom (5) and a material carrier rack (6) with material-gripping means (7) extending from the rack (6), whereby the rack (6) is connected to the boom (5) by angularly adjustable means (9, 10, 11), said moving support elements (3) being rotated by shafts (12, 12a, 12b), of which at least one is a drive shaft.

### TECHNICAL FIELD

The invention relates to lifting vehicles for lifting material in form of panels of e.g. glass, metal, gypsum, wood or granite, whereby human physical lifting intervention is avoided.

### PRIOR ART

U.S. Pat. No. 4,676,713 is an example of a lifting vehicle comprising a chassis with moving support elements, a mast mounted thereon, said mast being provided with a pivoting and telescopic boom and a material carrier rack with suction cups for securing material to the rack during transportation, whereby the rack is connected to the boom by hydraulic cylinders providing angular adjustment of the rack in a vertical and a horizontal direction and by a hydraulic motor providing rotation of the rack relative to the boom.

Using such vehicle to lift heavy burdens of maybe several hundreds of kilo is both economical, time saving and avoids work-related injuries.

The prior art vehicle needs a very big footprint and will not—due to its physical size and layout—be maneuvered easily inside a building and through narrow openings, which is one object of the present invention.

Moreover, the stability of the prior art vehicle during lifting operations is sensitive to laterally offsetting the foot of the mast by sliding its platform away from the centerline of the vehicle. Accordingly, one has to compromise between wheelbase and stability.

Furthermore, said vehicle shows a rather bulky construction of the pivoting and swinging mechanism comprising hydraulic cylinders attached to the carrier rack. Such constructions may leave little flexibility and space for maneuvering the vehicle.

Many such lifting vehicles are not handy enough to move inside buildings because of narrow and low openings between offices or rooms and consequently some manual handling still remains to be done on several occasions, and often the panels or plates to be carried require transportation through said openings sideways alongside the vehicle, which only adds to the need for a small wheelbase and a compact pivoting and swinging mechanism.

The drawbacks of the prior art vehicles mentioned above have been eliminated by the present invention.

### DISCLOSURE OF THE INVENTION

The present invention provides a lifting vehicle comprising a chassis with moving support elements, a tower structure rotatably mounted thereon, said tower being provided with a pivoting and telescopic boom and a material carrier rack with material gripping means extending from the rack, whereby the rack is connected to the boom by angularly adjustable means, said moving support elements being rotated by shafts, of which at least one is a drive shaft.

The moving support means include wheels and/or belts of e.g. a rubber or plastic material or steel.

At least one of the shafts is a telescopic shaft capable of being extended substantially perpendicular to the longitudinal direction of the vehicle in order to increase the wheel-base. Further, the telescopic shaft could be a two-part shaft, each shaft part serving a corresponding one of the wheels or belts.

The wheels or belts are in their initial positions positioned inside the chassis circumference in order to make it easier for the vehicle to negotiate narrow places without being caught in passageways etc.

The angularly adjustable means connecting the carrier rack with the free end of the boom is a very compact multi-axis joint allowing angular adjustment of the rack over an angle of 180° relative to the free boom end in a vertical plane and an angle of 180° relative to the free boom end in a horizontal plane, and allowing the rack to be rotated substantially around the axis of the boom. Accordingly, because of the combined actions of the boom and the multi-axis joint, the rack is offered many degrees of freedom for the movement of the rack. The rack can swing from a position flat down under the boom level to a position flat up above the boom, and the rack can swing laterally relative to the boom end and rotate in its own plane.

The rack is a construction known per se and comprises a grid structure carrying material-contacting cups, which can maintain contact or grip with the material by using vacuum or magnetism. In a preferred embodiment of the invention four cups are used, each cup being fed with vacuum to an extent equal to the full capacity of all four cups, whereby a single cup can hold the full load and all cups together offers 400% of the total vacuum needed.

The telescopic boom has one end coupled to the free end of the mast, and the coupling point is offset from the vertical rotation axis of the mast, which means that the momentum experienced from loading the rack is better balanced on the vehicle, resulting in better stability.

Due to rotation of the turntable with the mast and movement of the joint, it is possible to move the vehicle through narrow openings while the rack maintains a panel alongside the vehicle.

An advanced embodiment of the vehicle according to the invention comprises a remote control unit.

Preferred embodiments of the invention could be better understood from the following description and with reference to the drawing, showing in

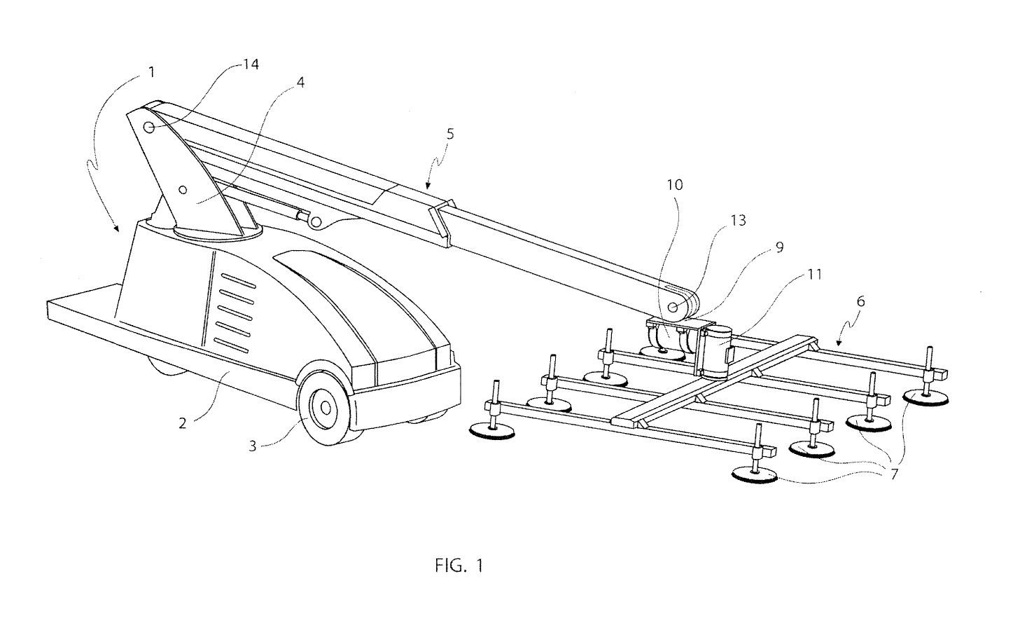

FIG. 1 a lifting vehicle according to the invention,

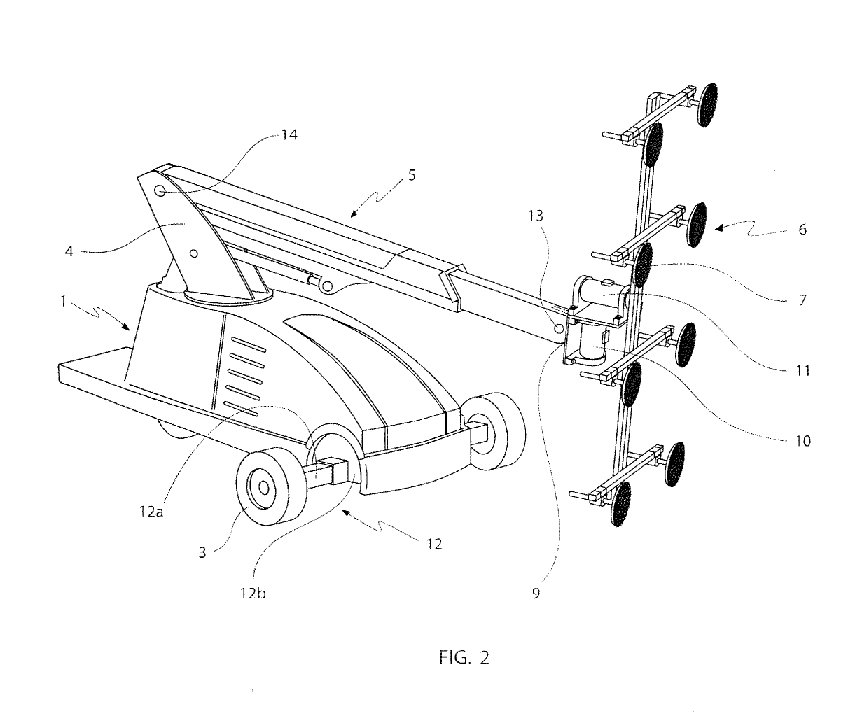

FIG. 2 a vehicle with a telescopic shaft comprising a box beam receiving an axle beam therein,

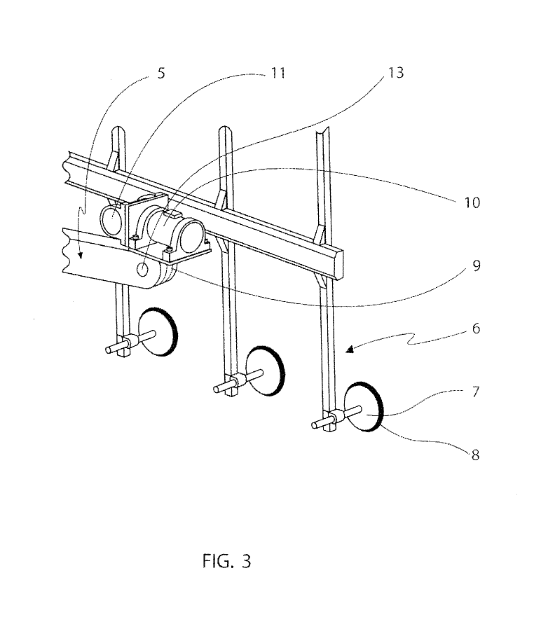

FIG. 3 a detailed view of a multi-axis joint according to the invention, and

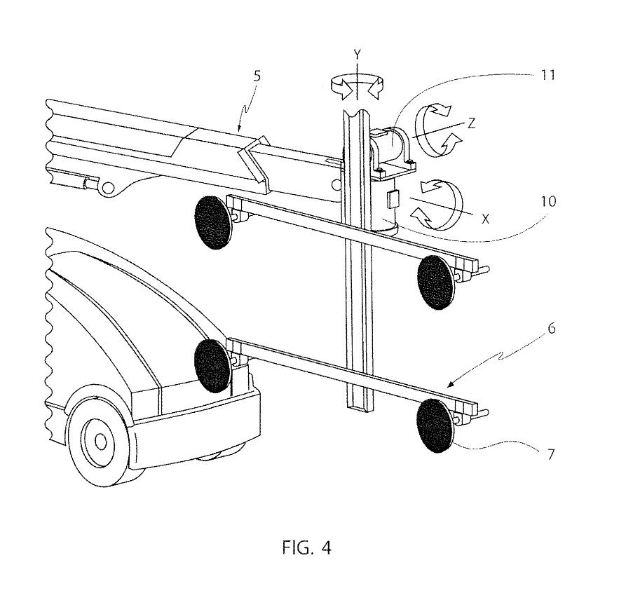

FIG. 4 a detailed view showing the rotational movements in XYZ directions performed by the joint in FIG. 3.

A vehicle 1 is shown in FIG. 1, comprising a chassis 2 with moving support elements 3, a mast 4 mounted thereon via a turntable (not visible), said mast 4 being provided with a pivoting and telescopic boom 5 and a material carrier rack 6 with suction cups 7 for securing material to the rack 6 during transportation, whereby the rack 6 is connected to the boom 5 by a multi-axis joint 9, 10, 11 providing angular adjustment of the rack 6 in a vertical and a horizontal direction and providing rotation of the rack 6 relative to the boom 5.

Referring now to FIG. 2, said moving support elements 3 are comprised of rubber wheels, and each wheel is attached to the end of a shaft 12. If required, the length of a shaft 12 can be extended by being of a telescopic nature having a box beam 12b fixed to the chassis and a sliding axle beam 12a received therein. The telescopic solution shown in FIG. 2 is used on the front wheels 3 in order to increase the wheelbase when needed. Front wheels 3 may roll or stand still while the wheelbase is adjusted. Usually the rear of the vehicle 1 is provided with either one wheel or two closely positioned wheels in order to improve the steerability of the vehicle. All the wheels 3 are kept on the inner side of the circumference of the vehicle 1 in order to require minimum width of passageways, etc.

The material carrier rack 6 is connected to the boom 5 by means of a multi-axis joint (FIG. 3) comprising a bracket 9, a first actuator 10 and a second actuator 11, whereby the bracket 9 can turn around a pivot 13 in the free end of the telescopic boom 5 and in a vertical plane relative to said free end. The first actuator 10 is built into and moves with the bracket 9 and is accordingly being moved in the vertical plane mentioned above, and the actuator 10 defines a right angle with the second actuator 11 and is able to rotate said actuator 11, which again rotates the rack 6.

The gripping means are large flat cups 7 provided with an opening for a suction tube (not shown) in order to provide the vacuum required, and the edge of each cup 7 is covered by a soft flexible material 8 to be locked airtight to the material to be gripped. The vacuum source is not shown.

Alternatively, if the material to be carried is magnetic, the cups 7 could be electromagnets charged from an electric source (not shown).

A pivot 14 near the top of the tower 4 (FIGS. 1 and 2) serves as a centre for a fixed end of the boom 5 to pivot around in a vertical plane. The tower 4 can rotate with a turntable around a vertical axis in a range of at least +/−90° relative to the longitudinal direction of the vehicle so it can move the rack 6 held in a position alongside the vehicle 1.

The pivot point 14 in the tower 4 is offset from said vertical rotation axis, which results in a lower momentum to deal with regarding the stability during lifting operations.

The preferred embodiment of the vehicle 1 does not provide seating for an operator, and lifting operations are controlled from a remote control unit.

The material to be lifted can be any kind of material in a substantially planar form, e.g. a panel of glass, plastic, wood, granite, gypsum or steel, and the like.

1. Lifting vehicle (1) comprising a chassis (2) with moving support elements (3), a tower structure (4) mounted thereon, said tower (4) being provided with a pivoting and telescopic boom (5) and a material carrier rack (6) with material-gripping means (7) extending from the rack (6), whereby the rack (6) is connected to the boom (5) by angularly adjustable means (9, 10, 11), said moving support elements (3) being rotated by shafts (12, 12a, 12b), of which at least one is a drive shaft.

2. Vehicle according to claim 1, wherein the moving support elements are wheels (3) of e.g. steel, having tires of a rubber or plastic material.

3. Vehicle according to claim 1, wherein the moving support elements (3) are belts of e.g. a rubber or plastic material or steel.

4. Vehicle according to any of claims 1-3, wherein at least one of the shafts (12a, 12b) is a telescopic shaft capable of being extended substantially perpendicular to the longitudinal direction of the vehicle (1) in order to increase the wheel-base.

5. Vehicle according to claim 4, wherein the telescopic shaft (12) is a two-part shaft, each shaft part (12a, 12b) serving a corresponding one of the wheels (3) or belts.

6. Vehicle according to any one of the preceding claims, wherein the wheels (3) or belts are in their initial position positioned inside the chassis circumference.

7. Vehicle according to any one of the preceding claims, wherein the angularly adjustable means connecting the carrier rack (6) with the free end of the boom (5) is a multi-axis joint (9, 10, 11) allowing the joint to be adjusted angularly over 180° in a vertical plane comprising the boom, and allowing the rack (6) to be swung horizontally and rotated around the axis of the boom (5).

8. Vehicle according to claim 7, wherein the multi-axis joint (9, 10, 11) comprises a bracket (9) hinged (13) to the free end of the boom (5), and a first actuator (10) fixedly connected with the bracket (9), and a second actuator (11) being connected in a right angle to the first actuator (10) and further coupled to the material gripping rack (6).

9. Vehicle according to claim 1, wherein the gripping means (7) grip the material by vacuum suction and are provided with a vacuum source to activate the gripping action.

10. Vehicle according to claim 1, wherein the gripping means (7) grip the material by magnetism and are provided with an electric source to activate the gripping action.

11. Vehicle according to any one of the preceding claims, wherein a pivot (14) near the top of the tower (4) serves as a pivot point for a fixed end of the boom (5) to pivot around in a vertical plane.

12. Vehicle according to any one of the preceding claims, wherein the tower (4) can rotate with a turntable around a vertical axis in a range of at least +/−90° relative to the longitudinal direction of the vehicle (1) so as to move the rack (6) held in a position alongside the vehicle (1).

13. Vehicle according to claim 11, wherein the pivot point (14) is offset from said vertical rotation axis of the tower (4).

14. Vehicle according to any one of the preceding claims, wherein operation of the lifting vehicle (1) and parts thereof is managed by a remote control.

15. Vehicle according to claim 1, wherein the material to be lifted is any kind of material in a substantially planar form, e.g. a panel of glass, plastic, wood, granite, gypsum or steel, and the like.
